(19) United States
(12) Patent Application Publication
(10) Pub. No.: US 2016/0277961 A1
(43) Pub. Date: Sep. 22, 2016

(54) METHODS AND SYSTEMS FOR CONTROLLING CONGESTION IN A COMMUNICATION NETWORK

(71) Applicant: TELEFONAKTIEBOLAGET L M ERICSSON (PUBL), Stockholm (SE)

(72) Inventors: Peter HEDMAN, Helsingborg (SE); Hans Bertil RÖNNEKE, Kungsbacka (SE); Shabnam SULTANA, Montreal (CA)

(21) Appl. No.: 14/786,090

(22) PCT Filed: Sep. 11, 2015
(86) PCT No.: PCT/IB2015/056998

§ 371 Date: Oct. 21, 2015

Related U.S. Application Data
(60) Provisional application No. 62/049,849, filed on Sep. 12, 2014.

(51) Int. Cl. H04W 28/02; H04W 4/00

(52) U.S. Cl. CPC H04W 28/0289; H04W 28/0231; H04W 4/005

(57) ABSTRACT

Methods and related systems for controlling congestion in a communication network are provided. The methods generally allow a network node to receive requests for transmission from user equipments, and to selectively, and generally temporarily, block certain requests for transmission if congestion has been determined to be associated with their destination addresses. The methods also generally allow user equipments to be notified of the rejection of their requests for transmission such as to refrain from immediately try to retransmit their requests. By controlling the transmission and processing of requests for transmission when their destination addresses are determined to be congested, congestion at these addresses can be at least mitigated.

### TECHNICAL FIELD

This disclosure generally relates to methods and systems for controlling congestion in communication networks.

### BACKGROUND

With the increasing number of network-enabled user equipment (UE) being put in operation, communication networks are required to support and handle an increasing volume of data. However, with a significant number of deployed UEs, some of which do not require human intervention to communicate, it is not uncommon for several UEs to try to access the same resource (e.g. server) at the same time.

This scenario can occur when the UEs are machine-to-machine (M2M) devices. Applications on such M2M devices tend to be very persistent and send multiple requests, and thus may cause high network load when many M2M devices, running the same application, try to access the same resource at the same time. This is especially true when the M2M applications are synchronized in time (e.g. smart meters all trying to report usage data at the same time).

A similar scenario may also occur when several smart phone users try to stream the same multimedia content (e.g. video) at the same time.

In such circumstances, when several UEs are trying to establish a connection with the same resource (e.g. server), the resource can become congested and unable to accept and serve all the attempted connections. In the worst case, if the number of connection requests reaches a certain level, the resource may simply crash.

When a resource (e.g. a server) that is used by a large number of UEs has become unavailable, e.g. because it has crashed, persistent behavior of such UEs re-trying to connect to the unavailable resource may cause high load on the network resources and in worst case even cause the network to become unstable or to be down.

One solution proposed to alleviate such problems is to group UEs and then temporarily block certain groups from establishing connections with the resource when the resource is determined to be congested.

The problem with such a solution is that each UE may have several applications running and a specific connection request may not be toward the congested resource even though the UE may have another application that sometimes communicate with the congested resource. In such case, since at least one application of the UE may communicate with the congested resource, the UE needs to belong to the specific group. However, though temporarily blocking one or more groups of UEs may alleviate the congested resource, blocking one or more groups of UEs will also block applications that do not target the congested resource.

Therefore, it would be desirable to provide methods and related systems that obviate or mitigate the above described problems.

### SUMMARY

In accordance with a broad aspect of the present invention, methods and related systems are provided to reduce congestion in a communication network by generally comparing the destination address or addresses comprised in a request (e.g. a service request, a communication request, an attach request, etc.) with a list of one or more addresses which have been determined to be unreachable (e.g. unavailable, down, congested, etc.), and by generally rejecting the request if there is a match between the destination address or addresses comprised in the request and at least one address comprised in the list of one or more destination addresses determined to be unreachable.

By generally blocking requests when the destination addresses are determined to be unreachable (e.g. unavailable, down, congested etc.), requests are blocked on a destination address basis and not on user equipment (UE) or group membership bases. Hence, by blocking requests on a destination address basis, only the applications on the UE that need to communicate with the unreachable resource(s) will be prevented to establish communication with such unreachable resource(s). In addition, controlling requests based on destination addresses generally requires limited processing on the network side and limited proactive configuration, either of the network components (e.g. network nodes) or of the UEs. In addition, a very selective and targeted control is possible, only affecting exactly the UEs and applications that send requests to the unreachable resource(s).

In accordance with a first exemplary embodiment, there is provided a method to control congestion in a communication network, the method comprising, at a network node, receiving a congestion notification comprising an address which congestion has been detected to be associated to, receiving a request for transmission from a user equipment (UE), the request for transmission comprising a destination address, determining whether the destination address comprised in the request for transmission matches the address comprised in the congestion notification, and, in accordance with determining whether the destination address comprised in the request for transmission matches the address comprised in the congestion notification, proceeding with the request for transmission if the destination address comprised in the request for transmission does not match the address comprised in the congestion notification, or transmitting a transmission rejection notification to the UE and refraining from proceeding with the request for transmission if the destination address comprised in the request for transmission matches the address comprised in the congestion notification.

In some embodiments, the congestion notification may comprise a plurality of addresses which congestion has been detected to be associated to. In such embodiments, the determining step may comprise determining whether the destination address comprised in the request for transmission matches at least one of the addresses comprised in the congestion notification. In such embodiments, depending on whether the destination address comprised in the request for transmission matches at least one of the addresses comprised in the congestion notification, the network node may either proceed with the request for transmission if the destination address comprised in the request for transmission matches none of the addresses comprised in the congestion notification, or transmit a transmission rejection notification to the UE and refrain from proceeding with the request for transmission if the destination address comprised in the request for transmission matches at least one of the addresses comprised in the congestion notification.

In some embodiments, the request for transmission may comprise a plurality of destination addresses. In such embodiments, the determining step may comprise determining which, if any, of the destination addresses comprised in the request for transmission match the address comprised in the congestion notification. In such embodiments, depending on whether any one of the destination addresses comprised in the request for transmission matches the address comprised in the congestion notification, the network node may either proceed with the request for transmission if none of the destination addresses comprised in the request for transmission matches the address comprised in the congestion notification, or transmit a transmission rejection notification to the UE and refrain from proceeding with the request for transmission if at least one of the destination addresses comprised in the request for transmission matches the address comprised in the congestion notification. Still, in such embodiments, when there are matches, the network node may add the matching destination address in the transmission rejection notification to inform the UE about the destination address which is to be avoided, at least temporarily.

In some embodiments, the congestion notification may comprise a plurality of addresses which congestion has been detected to be associated to, and the request for transmission may comprise a plurality of destination addresses. In such embodiments, the determining step may comprise determining if there is a match between any one of the destination addresses comprised in the request for transmission and any one of the addresses comprised in the congestion notification. In such embodiments, depending on whether there is one or more matches between any one of the destination addresses comprised in the request for transmission and any one of the addresses comprised in the congestion notification, the network node may either proceed with the request for transmission there is no match between any one of the destination addresses comprised in the request for transmission and any one of the addresses comprised in the congestion notification, or transmit a transmission rejection notification to the UE and refrain from proceeding with the request for transmission if at least one of the destination addresses comprised in the request for transmission matches at least one of the addresses comprised in the congestion notification. Still, in such embodiments, when there are one or more matches, the network node may add the one or more matching destination addresses in the transmission rejection notification to inform the UE about the destination address or addresses which is or are to be avoided, at least temporarily.

In some embodiments, the congestion notification may further comprise an allowance/rejection ratio (e.g. a fraction, a percentage value) indicative of what fraction of the requests for transmission may still be allowed (or rejected) despite a match between the destination address(es) comprised in the request for transmission and the address(es) comprised in the congestion notification. In such embodiments, even if there is a match between the destination address(es) comprised in the request for transmission and the address(es) comprised in the congestion notification, a certain ratio of the requests for transmission may still be allowed and proceeded with in order, for instance, to still provide a certain level of service while alleviating the congestion (e.g. by rejecting at least some requests for transmission). The determination of which requests for transmission should still be allowed and which should be rejected based on the allowance/rejection ratio may be done randomly or according to a predetermined sequence (e.g. round-robin).

In some embodiments, the congestion notification may further comprise at least one communications type for which the requests for transmission may be allowed (or rejected) despite a match between the destination address(es) comprised in the request for transmission and the address(es) comprised in the congestion notification. In such embodiments, when there is a match between the destination address(es) comprised in the request for transmission and the address(es) comprised in the congestion notification, the network node may further determine the at least one communication type of the request for transmission (e.g. by analyzing packet header(s), specific bit(s), etc.), determine whether the at least one communication type of the request for transmission matches the at least one communications type comprised in the congestion notification, and in accordance with determining whether the at least one communication type of the request for transmission matches the at least one communications type comprised in the congestion notification, either proceed with (or alternatively transmit a transmission rejection notification to the UE and refrain from proceeding with) the request for transmission if the at least one communication type of the request for transmission matches the at least one communication type comprised in the congestion notification, or transmit a transmission rejection notification to the UE and refrain from proceeding with (or alternatively proceed with) the request for transmission if the at least one communication type of the request for transmission does not match the at least one communication type comprised in the congestion notification. For instance, the communication type comprised in the congestion notification may be indicative of the allowance of high-priority data transmissions even when the destination address matches a congested destination address.

In some embodiments, the transmission rejection notification may comprise a waiting period value (e.g. a back-off timer value) indicating the time during which the UE cannot retransmit any request(s) for transmission for the matching destination address(es). In such embodiments, the UE may also refrain from transmitting new request(s) for transmission for the matching destination address(es) during the waiting period. The waiting period value may be determined by the network node itself or received with, or subsequent to, the congestion notification.

In some embodiments, the request for transmission is a service request or an attach request. In some embodiments, the destination addresses are IP addresses. In some embodiments, the network node is a Mobility Management Entity (MME) or a Serving GPRS Support Node (SGSN). In some embodiments, the UE is a machine-to-machine (M2M) device. In some embodiments, the UE is an Internet-of-things (IoT) device.

In accordance with a second exemplary embodiment, there is provided a network node, the network node comprising a communication interface and circuitry operatively connected to the communication interface. The circuitry is adapted to receive a congestion notification, via the communication interface, the congestion notification comprising an address which congestion has been detected to be associated to, receive a request for transmission, via the communication interface, from a user equipment (UE), the request for transmission comprising a destination address, determine whether the destination address comprised in the request for transmission matches the address comprised in the congestion notification, and in accordance with determining whether the destination address comprised in the request for transmission matches the address comprised in the congestion notification, proceed with the request for transmission if the destination address comprised in the request for transmission does not match the address comprised in the congestion notification, or cause the communication interface to transmit a transmission rejection notification to the UE and refrain from proceeding with the request for transmission if the destination address comprised in the request for transmission matches the address comprised in the congestion notification.

In some embodiments, the congestion notification may comprise a plurality of addresses which congestion has been detected to be associated to, and the request for transmission may also comprise a plurality of destination addresses. In such embodiments, the circuitry may be adapted to determine if any one of the destination addresses comprised in the request for transmission matches any one of the addresses comprised in the congestion notification, and, in accordance with determining if any one of the destination addresses comprised in the request for transmission matches any one of the addresses comprised in the congestion notification, proceed with the request for transmission if there is no match between any one of the destination addresses comprised in the request for transmission and any one of the addresses comprised in the congestion notification, or cause the communication interface to transmit a transmission rejection notification to the UE and refrain from proceeding with the request for transmission if at least one of the destination addresses comprised in the request for transmission matches at least one of the addresses comprised in the congestion notification. In such embodiments, the transmission rejection notification may comprise a list of the one or more destination addresses comprised in the request for transmission which match one or more addresses comprised in the congestion notification to inform the UE about the destination address or addresses which is or are to be avoided, at least temporarily.

In some embodiments, the congestion notification may further comprise an allowance/rejection ratio. In such embodiments, the circuitry may be further adapted to, when the circuitry determines that the destination address(es) comprised in the request for transmission match(es) the address(es) comprised in the congestion notification, determine whether the request for transmission may still be allowed according to the allowance/rejection ratio, and, in accordance with determining whether the request for transmission may still be allowed according to the allowance/rejection ratio, proceed with the request for transmission if the request for transmission should still be allowed, or cause the communication interface to transmit a transmission rejection notification to the UE and refrain from proceeding with the request for transmission if the request for transmission should not still be allowed.

In some embodiments, the congestion notification may further comprise at least one communication type. In such embodiments, the circuitry may be further adapted to, when the destination address(es) comprised in the request for transmission match(es) the address(es) comprised in the congestion notification, determine at least one communication type from the request for transmission, determine whether the at least one communication type of the request for transmission matches the at least one communication type comprised in the congestion notification, and, in accordance with determining whether the at least one communication type of the request for transmission matches the at least one communication type comprised in the congestion notification, proceed with the request for transmission if the at least one communication type of the request for transmission matches the at least one communication type comprised in the congestion notification, or cause the communication interface to transmit a transmission rejection notification to the UE and refrain from proceeding with the request for transmission if the at least one communication type of the request for transmission does not match the at least one communication type comprised in the congestion notification. Alternatively, the circuitry could be adapted to proceed with the request for transmission if the at least one communication type of the request for transmission does not match the at least one communication type comprised in the congestion notification, or cause the communication interface to transmit a transmission rejection notification to the UE and refrain from proceeding with the request for transmission if the at least one communication type of the request for transmission matches the at least one communication type comprised in the congestion notification.

In some embodiments, the transmission rejection notification may comprise a waiting period value indicating the time during which the UE cannot retransmit any request(s) for transmission for the matching destination address(es). In such embodiments, the UE may also refrain from transmitting new request(s) for transmission for the matching destination address(es) during the waiting period. The waiting period value may be determined by the network node itself or received with, or subsequent to, the congestion notification.

In some embodiments, the request for transmission is a service request or an attach request. In some embodiments, the destination addresses are IP addresses. In some embodiments, the circuitry comprises a processor and a memory. In some embodiments, the network node is a Mobility Management Entity (MME) or a Serving GPRS Support Node (SGSN). In some embodiments, the UE is a machine-to-machine (M2M) device. In some embodiments, the UE is an Internet-of-things (IoT) device.

In accordance with a third exemplary embodiment, there is provided a method to control congestion in a communication network, the method comprising, at a user equipment (UE), transmitting a request for transmission to a network node, the request for transmission comprising a destination address, and receiving a transmission rejection notification from the network node.

In some embodiments, the request for transmission may comprise a plurality of destination addresses. In some embodiments, the transmission rejection notification may comprise a list of one or more of the destination addresses which match one or more addresses which congestion has been detected to be associated to. In such embodiments, the method may further comprise transmitting a modified request for transmission to the network node in which the one or more of the destination addresses comprised in the list are removed. In some embodiments, the transmission rejection notification may comprise a waiting period value in addition to a list of one or more of the destination addresses which match one or more addresses which congestion has been detected to be associated to. In such embodiments, the method may further comprise transmitting to the network node a first request for transmission in which the one or more of the destination addresses comprised in the list are removed, and transmitting to the network node a second request for transmission comprising the one or more of the destination addresses comprised in the list after an expiration of the waiting period.

In some embodiments, the transmission rejection notification may comprise a waiting period value. In some embodiments, the method may further comprise retransmitting the request for transmission to the network node after an expiration of the waiting period. In some embodiments, the method may further comprise discarding the rejected request for transmission, and notifying the application(s), having packets in the transmission buffer, that transmission has failed. In such embodiments, no new requests for transmission would generally be generated until the expiration of the waiting period.

In some embodiments, the transmission rejection notification may further comprise, in addition to the waiting period value, at least one address which congestion has been detected to be associated to. In such embodiments, the method may further comprise, until the expiration of the waiting period, refraining from transmitting a new request for transmission to the network node, the new request for transmission comprising a destination address, if the destination address of the new request for transmission is identical to the at least one address comprised in the transmission rejection notification. When the UE refrains to transmit a new request for transmission to the network node when the new request for transmission is addressed to the same address comprised in the transmission rejection notification during the waiting period, the UE acts preemptively in reducing congestion by waiting for the expiration of the waiting period to transmit new requests for transmission to the address or addresses which congestion has been detected to be associated to.

In some embodiments, the request for transmission is a service request or an attach request. In some embodiments, the destination addresses are IP addresses. In some embodiments, the network node is a Mobility Management Entity (MME) or a Serving GPRS Support Node (SGSN). In some embodiments, the UE is a machine-to-machine (M2M) device. In some embodiments, the UE is an Internet-of-things (IoT) device.

In accordance with a fourth exemplary embodiment, there is provided a user equipment, the user equipment comprising a communication interface and circuitry operatively connected to the communication interface. The circuitry is adapted to transmit a request for transmission to a network node via the communication interface, the request for transmission comprising a destination address, and receive a transmission rejection notification from the network node via the communication interface.

In some embodiments, the request for transmission may comprise a plurality of destination addresses. In such embodiments, the transmission rejection notification may comprise a list of one or more of the destination addresses which match one or more addresses which congestion has been detected to be associated to. In such embodiments, the circuitry may be further adapted to transmit to the network node via the communication interface a modified request for transmission in which the one or more of the destination addresses comprised in the list are removed.

In some embodiments, the request for transmission may comprise a plurality of destination addresses. In such embodiments, the transmission rejection notification may comprise a waiting period value in addition to a list of one or more of the destination addresses which match one or more addresses which congestion has been detected to be associated to. In such embodiments, the circuitry may be further adapted to transmit to the network node via the communication interface a first request for transmission in which the one or more of the destination addresses comprised in the list are removed, and transmit to the network node via the communication interface a second request for transmission comprising the one or more of the destination addresses comprised in the list after an expiration of the waiting period.

In some embodiments, the transmission rejection notification may comprise a waiting period value. In some embodiments, the circuitry may be further adapted to cause the communication interface to retransmit the request for transmission to the network node after an expiration of the waiting period. In some embodiments, the circuitry may be further adapted to discard the rejected request for transmission, and notify the application(s), having packets in the transmission buffer, that transmission has failed. In such embodiments, no new requests for transmission would generally be generated until the expiration of the waiting period.

In some embodiments, the transmission rejection notification may comprise, in addition to a waiting period value, at least one address which congestion has been detected to be associated to. In such embodiments, the circuitry may be further adapted to determine if the destination address of a new request for transmission matches the at least one address comprised in the transmission rejection notification, and until the expiration of the waiting period, refrain from transmitting the new request for transmission to the network node if the destination address of the new request for transmission matches the at least one address comprised in the transmission rejection notification.

In some embodiments, the request for transmission is a service request or an attach request. In some embodiments, the destination addresses are IP addresses. In some embodiments, the circuitry comprises a processor and a memory. In some embodiments, the network node is a Mobility Management Entity (MME) or a Serving GPRS Support Node (SGSN). In some embodiments, the UE is a machine-to-machine (M2M) device. In some embodiments, the UE is an Internet-of-things (IoT) device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached figures, wherein:

FIG. 1 is a diagram of an exemplary network architecture in which the present invention can be deployed.

FIGS. 2A and 2B are message flow and signaling diagrams for controlling congestion according to an exemplary embodiment.

FIG. 3 is a message flow and signaling diagram for controlling congestion according to another exemplary embodiment.

FIGS. 4A and 4B are message flow and signaling diagrams for controlling congestion according to another exemplary embodiment.

FIGS. 5A and 5B are message flow and signaling diagrams for controlling congestion according to another exemplary embodiment.

FIG. 6 is a message flow and signaling diagram for controlling congestion according to another exemplary embodiment.

FIGS. 7A and 7B are message flow and signaling diagrams for controlling congestion according to another exemplary embodiment.

FIG. 8 is a method flowchart according to the embodiment of FIGS. 2A, 2B, and 3 as performed by a network node.

FIG. 9 is a method flowchart according to the embodiment of FIGS. 4A and 4B, as performed by a network node.

FIG. 10 is a method flowchart according to the embodiment of FIGS. 5A and 5B, as performed by a network node.

FIG. 11 is a method flowchart according to the embodiment of FIGS. 2A, 2B, 4A, 4B, 5A and 5B, as performed by a user equipment.

FIG. 12 is a method flowchart according to the embodiment of FIGS. 2A and 2C, as performed by a user equipment.

FIG. 13 is a method flowchart according to the embodiment of FIG. 6, as performed by a user equipment.

FIG. 14 is a method flowchart according to the embodiment of FIGS. 7A and 7B, as performed by a user equipment.

FIG. 15 is a block diagram of an exemplary embodiment of a network node.

FIG. 16 is a block diagram of an exemplary embodiment of a user equipment.

FIG. 17 is another block diagram of an exemplary embodiment of a network node.

FIG. 18 is another block diagram of an exemplary embodiment of a user equipment.

### DETAILED DESCRIPTION

The present invention is generally directed to methods and related systems to control congestion in communication network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

According to various embodiments of the present invention, congestion at specific addresses (e.g. IP addresses) in communication networks can be reduced or at least mitigated by generally blocking requests from transmission which are directed to these congested or otherwise unreachable addresses. In addition, by performing this blocking based on the destination addresses of the requests for transmission and not on the identities of the devices or groups of devices sending these requests, a more targeted blocking can be performed.

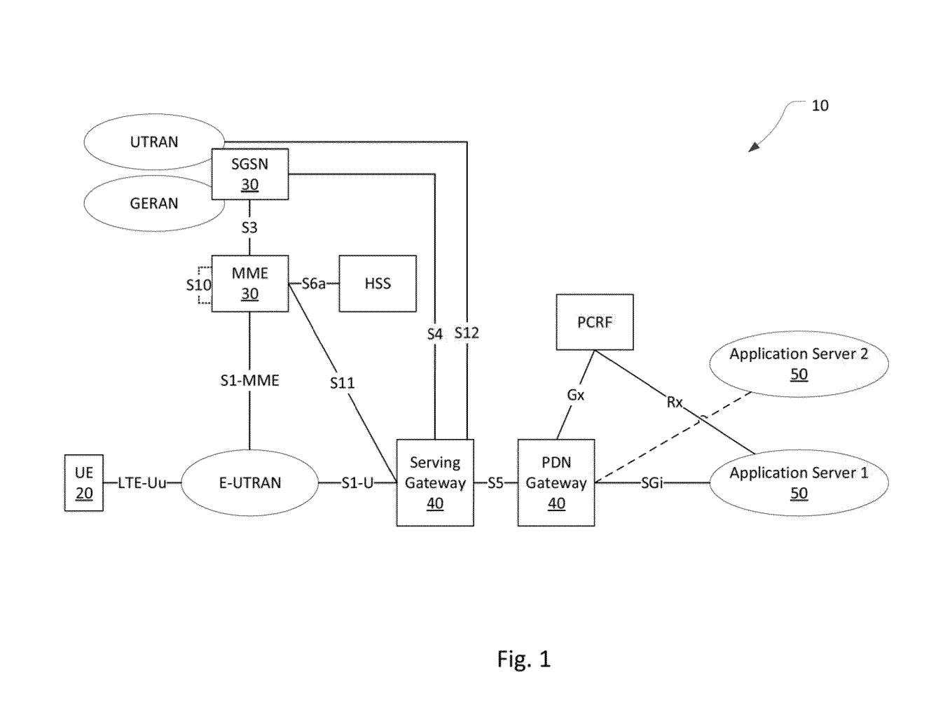

An exemplary network 10 in which the present invention can be deployed is illustrated in FIG. 1. The network 10 generally comprises a plurality of user equipments or UEs 20 (e.g. mobile terminals, smart phones, machine-to-machine (M2M) devices, Internet-of-thing (IoT) devices, etc.) (only one is shown for clarity), each of which running one or more applications (not shown). For instance, in the present network 10, the user equipment 20 may be M2M devices (e.g. smart electric meters) running various application such as electric usage monitoring, electric usage reporting, etc. The user equipments 20 are connected, by wire or wirelessly, to serving nodes 30 (e.g. Mobility Management Entity (MME), Serving GPRS Support Node (SGSN), etc.). In the present network 10, the serving nodes 30 are further in communication with nodes and/or servers 50 via one or more gateway nodes 40 (e.g. Serving Gateway (SGW), Packet Data Network Gateway (PGW), etc.).

In network 10, when an application running in a UE 20 wants to access a resource located on a server 50, the application sends a request for transmission to the serving node 30 to which the UE, running the requesting application, is associated.

In turn, the serving node 30 forwards the request for transmission toward the destination node 50. However, if the destination node 50 is congested, i.e. it receives more requests that it can handle, then the request for transmission might be dropped. Having no response from the destination node 50, the application will simply retransmit its request for transmission. Unfortunately, if several UEs 20 running the same applications repeatedly retransmit requests for transmission toward a congested destination node 50, then the state of congestion of the destination is unlikely to change. Such a scenario can happen when, for instance, several smart meter devices try to send usage reports all at the same time to the same destination node 50.

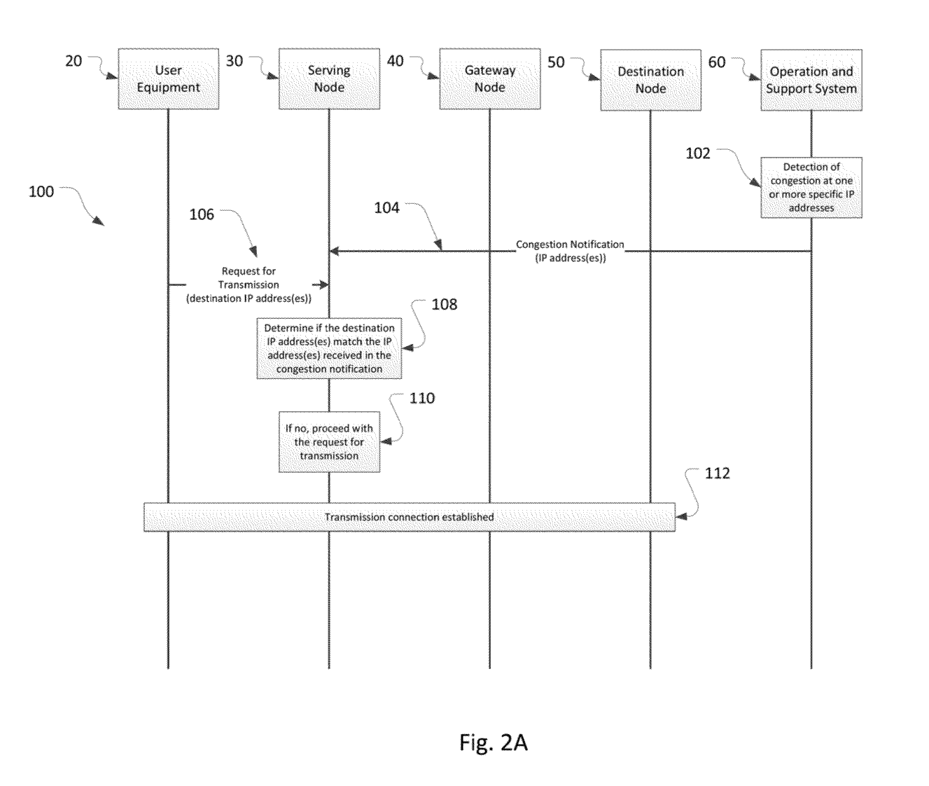

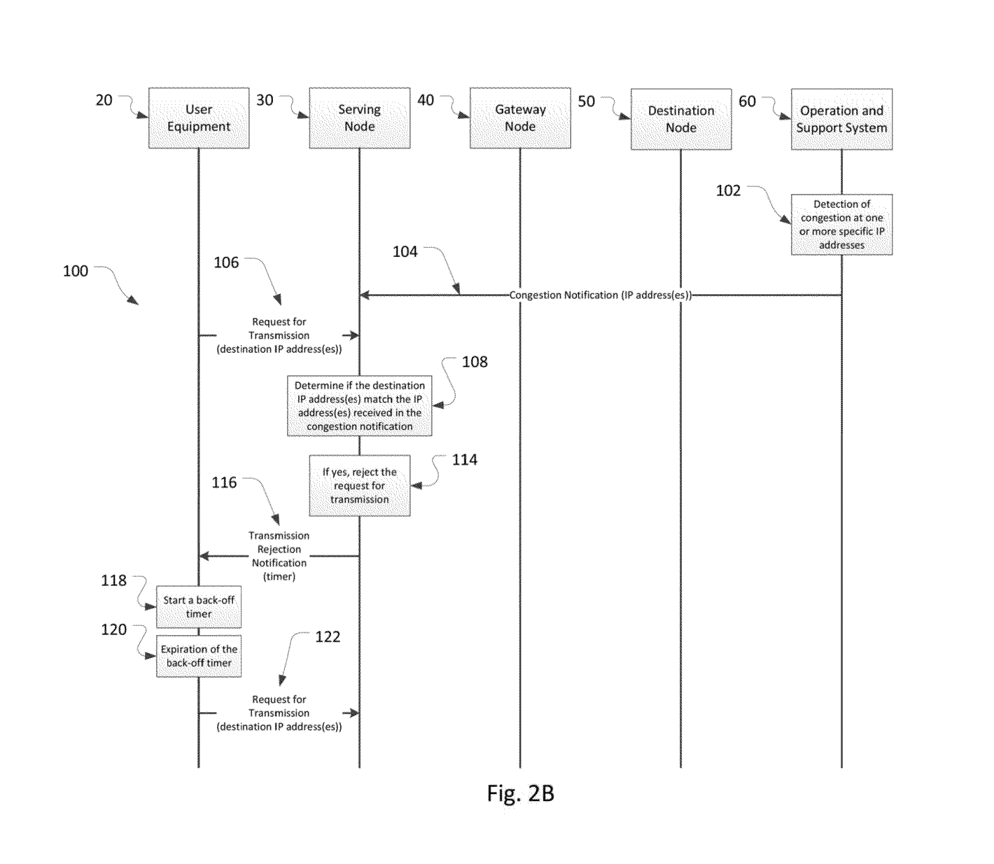

Referring now to FIGS. 2A and 2B, an exemplary message flow and signaling diagram 100 according to an embodiment of the present invention will now be described. In the embodiment 100, at 102, an operation and support system (OSS) (e.g. network operation center) 60 detects congestion at one or more IP addresses in the network 10. The detection of congestion could be performed according to various metrics which are readily known in the art (e.g. dropped packets, latency, no response, etc.). The OSS 60 then sends, at 104, a congestion notification to the serving node 30. The congestion notification comprises the one or more IP addresses in the network 10 which congestion has been detected to be associated to. Also, even though FIGS. 2A and 2B show only one serving node 30, it is to be understood that the OSS 60 may broadcast the congestion notification such that all the serving nodes 30 in the network 10 receive the congestion notification.

Later, the serving node 30, which has previously received the congestion notification from the OSS 60, receives, at 106, a request for transmission from a user equipment (UE) 20. The request for transmission comprises at least one destination IP address to which IP packets are to be transmitted. At 108, the serving node 30 determines whether the at least one destination address comprised in the request for transmission matches the at least one congested addressed comprised in the congestion notification.

In the event that there is no match, then the serving node 30 proceeds with the request for transmission, at 110, and a connection is ultimately established between the UE 20 and the destination node 50, at 112.

However, if there is a match between the at least one destination address comprised in the request for transmission and the at least one congested addressed comprised in the congestion notification, then the serving node 30 rejects the request for transmission, at 114, and transmits, at 116, a transmission rejection notification to the UE 20. In the present embodiment, the transmission rejection notification comprises a timer value which is used by the UE 20 to start a back-off timer, at 118, during which the UE 20 will refrain from retransmitting the rejected request for transmission. Once the timer expires, at 120, the UE 20 retransmits, at 122, the request for transmission to the serving node 30.

Once the UE retransmits the request for transmission, at 122, the retransmitted request for transmission will be processed by the serving node 30 as a new request for transmission which can be either proceeded with or rejected depending on the congestion status of the destination address(es).

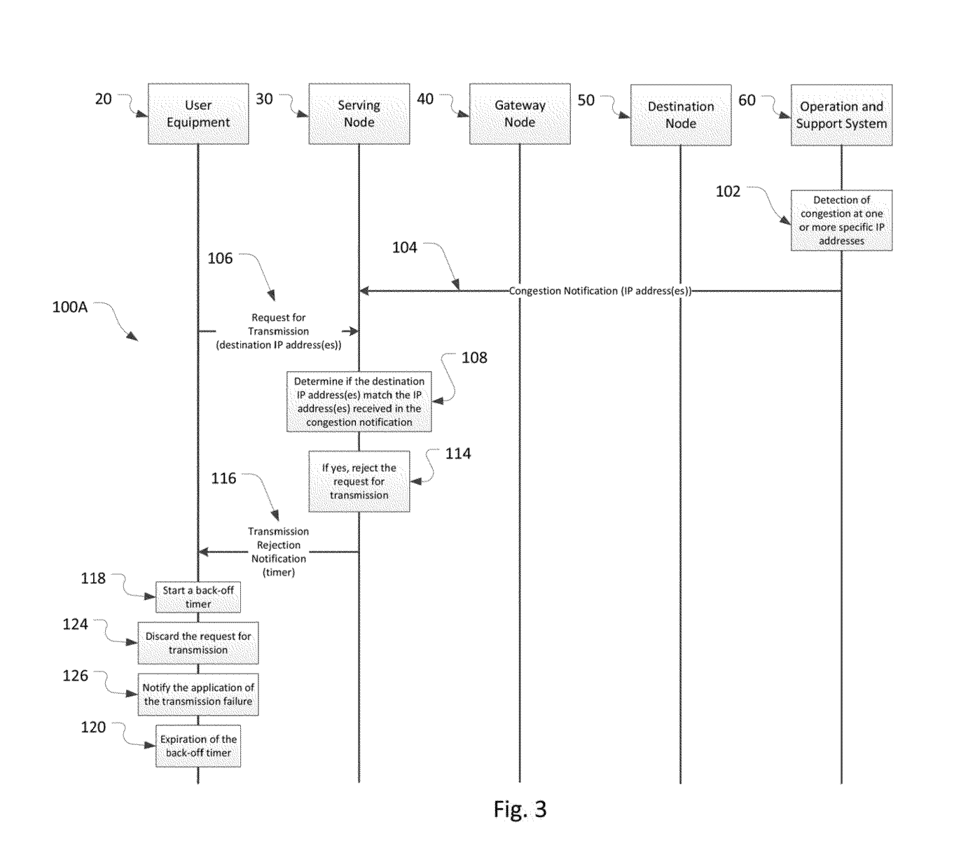

Referring now to FIG. 3, in a variant 100A of the embodiment 100, once the UE 20 receives the transmission rejection notification, at 116, it starts a timer using the timer value comprised in the transmission rejection notification, at 118, and discards the rejected request for transmission, at 124. Then, at 126, the UE 20 notifies the application which was responsible for the request for transmission (the application having IP packets to be transmitted) that the transmission has failed.

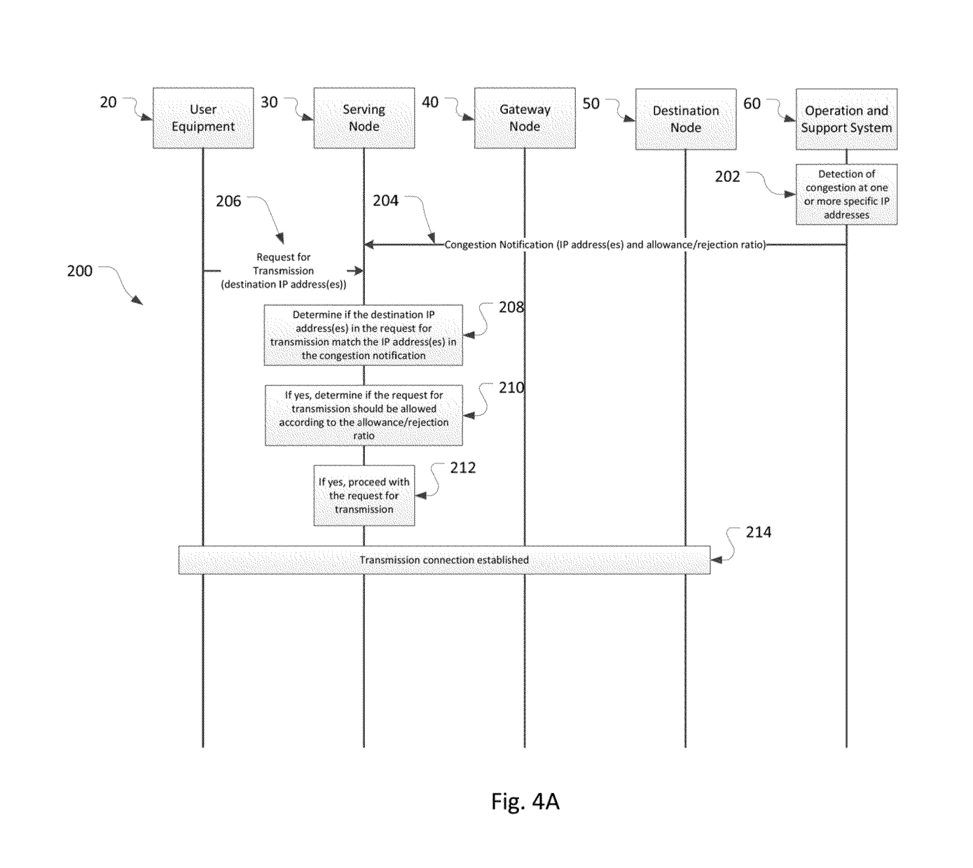

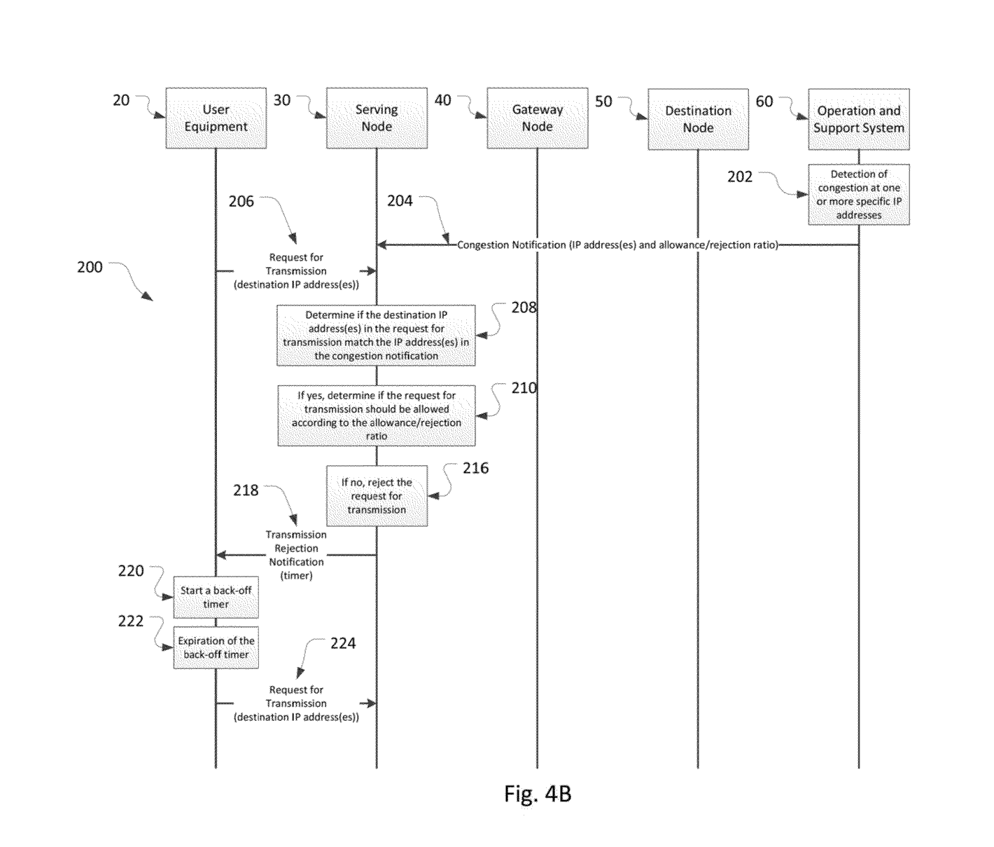

Referring now to FIGS. 4A and 4B, an exemplary message flow and signaling diagram 200 according to another embodiment of the present invention will now be described. In the embodiment 200, the OSS 60 detects congestion, at 202, at one or more addresses. The OSS 60 then sends (e.g. broadcasts) a congestion notification, at 204, to all the serving nodes 30. Whereas in the embodiment 100, the congestion notification comprised only the one or more addresses of nodes which congestion has been detected to be associated to, in embodiment 200, the congestion notification further comprises at least one allowance/rejection ratio. The allowance/rejection ratio, which can be in the form of a percentage, indicates to the serving nodes 30 what ratio of requests for transmission should still be allowed to be proceeded with even if their destination addresses match the congested addresses comprised in the congestion notification. Depending on the actual implementation, there may be one allowance/rejection ratio for all the congested destination addresses, different allowance/rejection ratios for different groups of congested destination addresses, or one allowance/rejection ratio per congested destination address.

Later, at 206, the serving node 30 receives a request for transmission from a UE 20. The request for transmission comprises at least one destination address. Then, as in embodiment 100, the serving node 30 compares, at 208, the at least one destination address of the request for transmission with the congested address(es) of the congestion notification.

If there is no match, the serving node 30 proceeds with the request for transmission and a connection between the UE 20 and the destination node 50 is established as in FIG. 2A.

However, if there is a match between the at least one destination address of the request for transmission and at least one congested address(es) of the congestion notification, then the serving node 30 determines, at 210, whether the request for transmission should still be allowed according to the allowance/rejection ratio. For instance, if the allowance/rejection ratio is 1 in 5 (or 20%) of the requests for transmission should be allowed despite a match between the at least one destination address of the request for transmission and at least one congested address of the congestion notification, then the serving node 30 determines whether the request of transmission is part of the 20% of the requests for transmission that should be allowed or part of the 80% that should not be allowed. This determination can be performed by various methods (e.g. random selection, round-robin selection, etc.).

If the request for transmission is part of the requests for transmission that should be allowed, then the serving node 30 proceeds with the request for transmission, at 212. A connection between the UE 20 and the destination node 50 is then established at 214.

If the request for transmission is part of the requests for transmission that should not be allowed, then the serving node 30 rejects the request for transmission, at 216, and transmits, at 218, a transmission rejection notification to the UE 20. In the present embodiment, the transmission rejection notification comprises a timer value which the UE 20 uses to start a back-off timer at 220 during which the UE 20 refrains from retransmitting the rejected request for transmission. When the timer expires, at 222, the UE 20 retransmits the rejected request for transmission. Again, this retransmitted request for transmission will be considered as a new request for transmission by the serving node 30.

By having an allowance/rejection ratio, the serving node 30 can still proceed with requests for transmission that would otherwise be rejected. This allows at least some requests for transmission to be proceeded with while still alleviating the congestion by reducing the number of requests for transmission which are directed to congested address(es). Notably, the allowance/rejection ratio may be dynamic and evolve over time according to the level of congestion detected at the congested address(es). For instance, the allowance/rejection ratio could start very low (e.g. an allowance rate of 5%) when the level of congestion is very high, and gradually increase as the level of congestion decreases, due, at least in part, to the congestion control in accordance with the present invention.

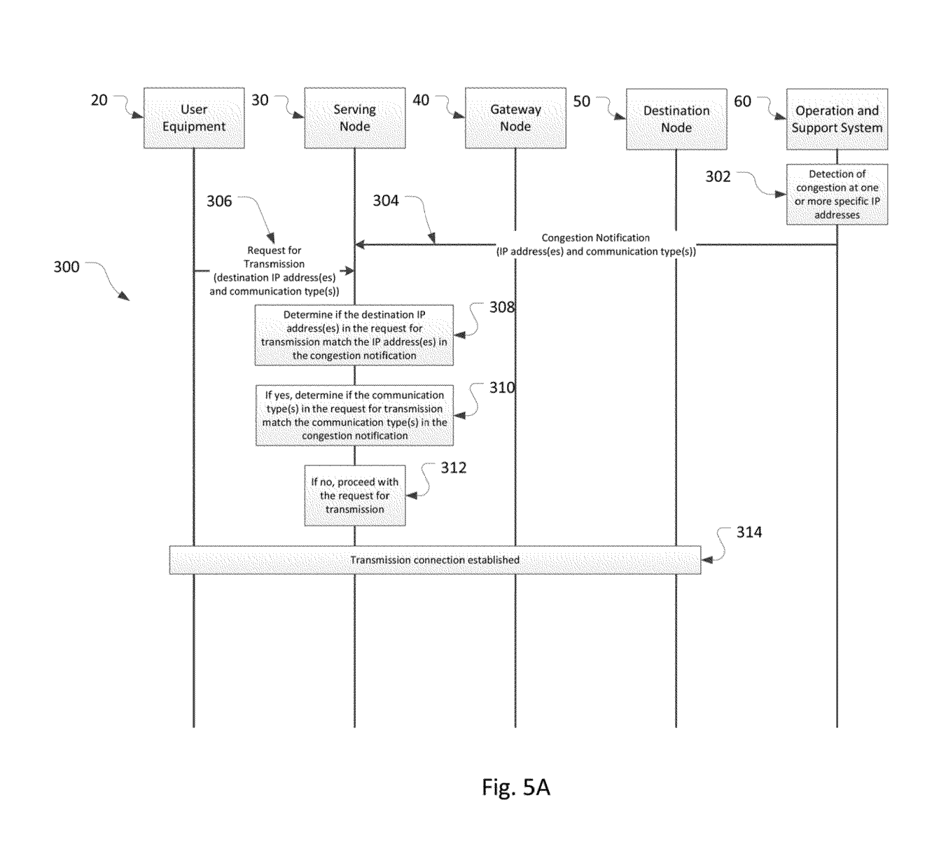

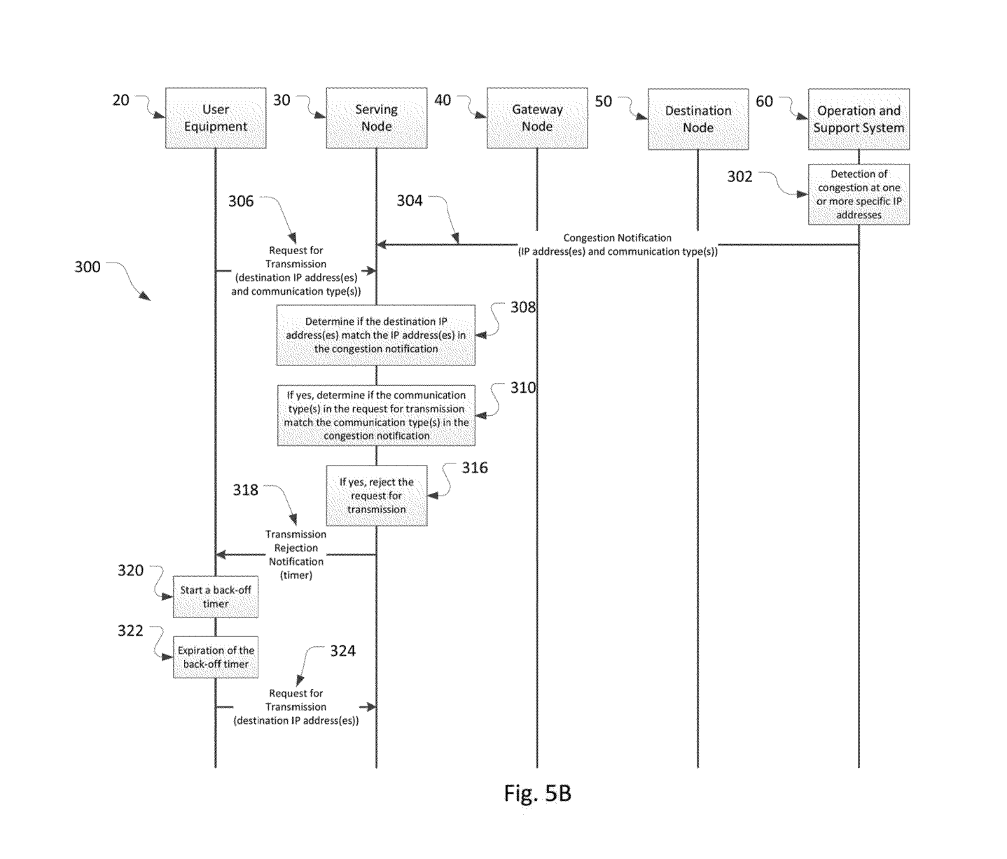

Referring now to FIGS. 5A and 5B, an exemplary message flow and signaling diagram 300 according to another embodiment of the present invention will now be described. In the embodiment 300, the OSS 60 detects congestion, at 302, at one or more addresses. The OSS 60 then sends (e.g. broadcasts) a congestion notification, at 304, to all the serving nodes 30. In embodiment 300, the congestion notification further comprises, in addition to the one or more addresses which congestion has been detected to be associated to, one or more communication types. Similar to the allowance/rejection ratio of embodiment 200, the communication types indicate to the serving nodes 30 which types(s) of communication should still be allowed (or rejected) even if the destination address(es) of the requests for transmission match the congested address(es) comprised in the congestion notification. The communication types may include priority information (e.g. high, medium and low priorities), communication protocol information (e.g. TCP, UDP, etc.), data type information (e.g. time sensitivity of the data), etc.

Later, at 306, the serving node 30 receives a request for transmission from a UE 20. The request for transmission comprises at least one destination address and at least one communication type. Notably, the communication type of the request for transmission could be extracted or deduced by the serving node 30 by examining, for instance, header(s), specific bit(s), etc.

Then, as in embodiments 100 and 200, the serving node 30 compares, at 308, the at least one destination address of the request for transmission with the congested address(es) of the congestion notification.

If there is no match, the serving node 30 proceeds with the request for transmission and a connection between UE 20 and destination node 50 is established as in FIG. 2A.

However, if there is a match between the at least one destination address of the request for transmission and at least one congested address(es) of the congestion notification, then the serving node 30 determines, at 310, whether the at least communication type of the request for transmission matches at least one communication types of the congestion notification.

If the at least communication type of the request for transmission matches at least one communication types of the congestion notification, then the serving node 30 either allows and proceeds with the request for transmission, or rejects the request for transmission. In the present embodiment, when there is no match between the communication types, the serving node 30 proceeds with the request for transmission, at 312, and a connection between the UE 20 and the destination node 50 is established, at 314.

Otherwise, if there is a match between the communication types, then the serving node 30 rejects the request for transmission, at 316, and transmits, at 318, a transmission rejection notification to the UE 20. In the present embodiment, the transmission rejection notification comprises a timer value which the UE 20 uses to start a back-off timer at 320 during which the UE 20 refrains from retransmitting the rejected request for transmission. When the timer expires, at 322, the UE 20 retransmits the rejected request for transmission. Again, this retransmitted request for transmission will be considered as a new request for transmission by the serving node 30.

By adding the communication types as another criterion for allowing or rejecting requests for transmission, requests for transmission of certain communication types could still be allowed to be proceeded with, even when congestion is detected at the destination address. For instance, if the communication type is an indication of time sensitivity of the data to be transmitted, requests for transmission of time-sensitive data could still be allowed, even when there is congestion, while be requests for transmission of time-insensitive data would be rejected. Understandably, the communication types could include multiple criteria, for instance level of priority and time sensitivity. In that sense, the serving node 30 could perform nested determinations.

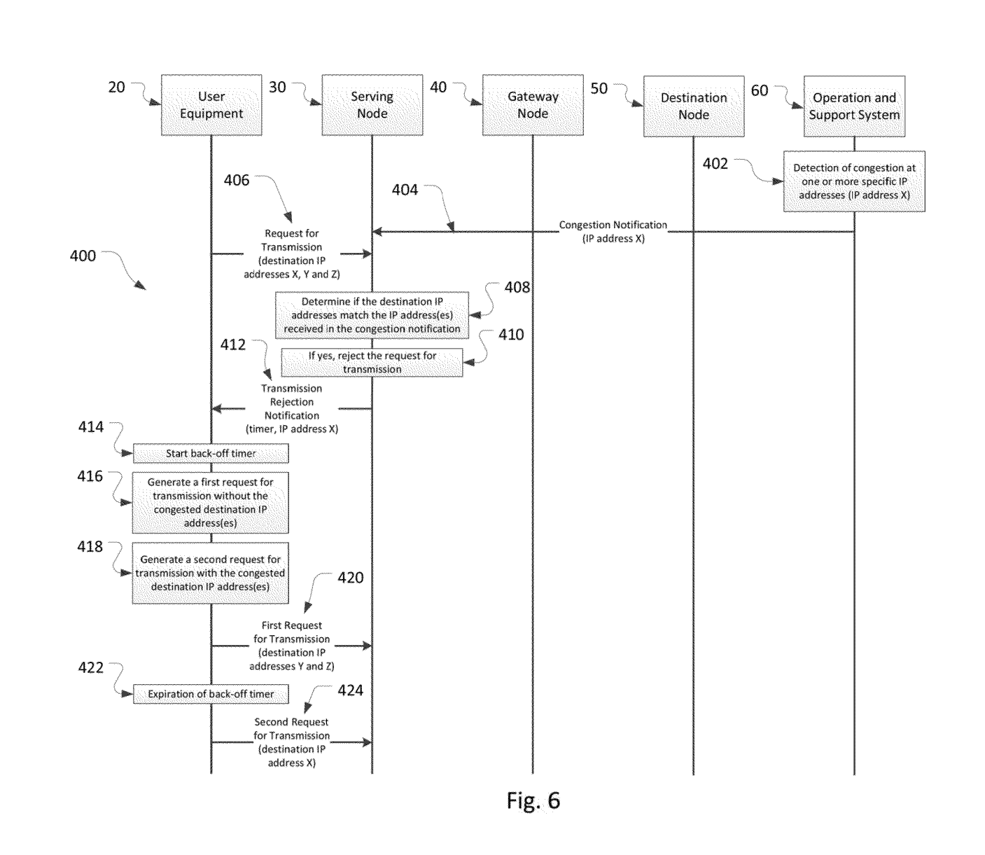

Referring now to FIG. 6, an exemplary message flow and signaling diagram 400 according to another embodiment of the present invention will now be described. In embodiment 400, the OSS 60 detects congestion, at 402, at one or more addresses. The OSS 60 then sends (e.g. broadcasts) a congestion notification, at 404, to all the serving nodes 30. In the embodiment 400, the congestion notification comprises the one or more IP addresses which congestion has been determined to associated to.

Later, at 406, the serving node 30 receives a request for transmission from a UE 20. The request for transmission comprises at least two destination addresses.

Then, as in previous embodiments 100, 200 and 300, the serving node 30, determines, at 408, whether at least one of the destination address of the request for transmission matches at least one of the congested address(es) of the congestion notification.

If there is no match, the serving node 30 proceeds with the request for transmission and a connection between UE 20 and destination node 50 is established as in FIG. 2A.

However, if there is a match between at least one of the destination addresses of the request for transmission and at least one of the congested addresses of the congestion notification, then the serving node 30 rejects, at 410, the request for transmission, and transmits, at 412, a transmission rejection notification to UE 20. In the present embodiment, the transmission rejection notification comprises a timer value and a list of the matching address(es) (i.e. the destination address(es) of the request for transmission which match the congested address(es)). At 414, UE 20 starts a back-off timer with the timer value. Then, at 416 and 418, the UE 20 generates two new requests for transmission based on the rejected request for transmission. In one of the new request for transmission, the new request for transmission comprises only destination address(es) which are not included in the transmission rejection notification. In the other of the new request for transmissions, the new request for transmission comprises only destination address(es) which are included in the transmission rejection notification.

Then, at 420, typically before the expiration of the timer, UE 20 transmits the new request for transmission comprising only destination address(es) which are not included in the transmission rejection notification.

While the back-off timer is active, the UE refrains from transmitting the new request for transmission comprising only destination address(es) which are included in the transmission rejection notification. The UE 20 only transmits this new request for transmission, at 424, when the timer expires, at 422.

By allowing the UE 20 to split a rejected request for transmission in two requests for transmission, one directed to non-congested address(es), and one directed to congested destination address(es), the UE 20 is able to adjust and modify the requests for transmission it transmits based on congestion information received in transmission rejection notifications. This also prevents transmissions directed to non-congested addresses from be blocked or delayed because they are grouped with transmissions directed to congested addresses.

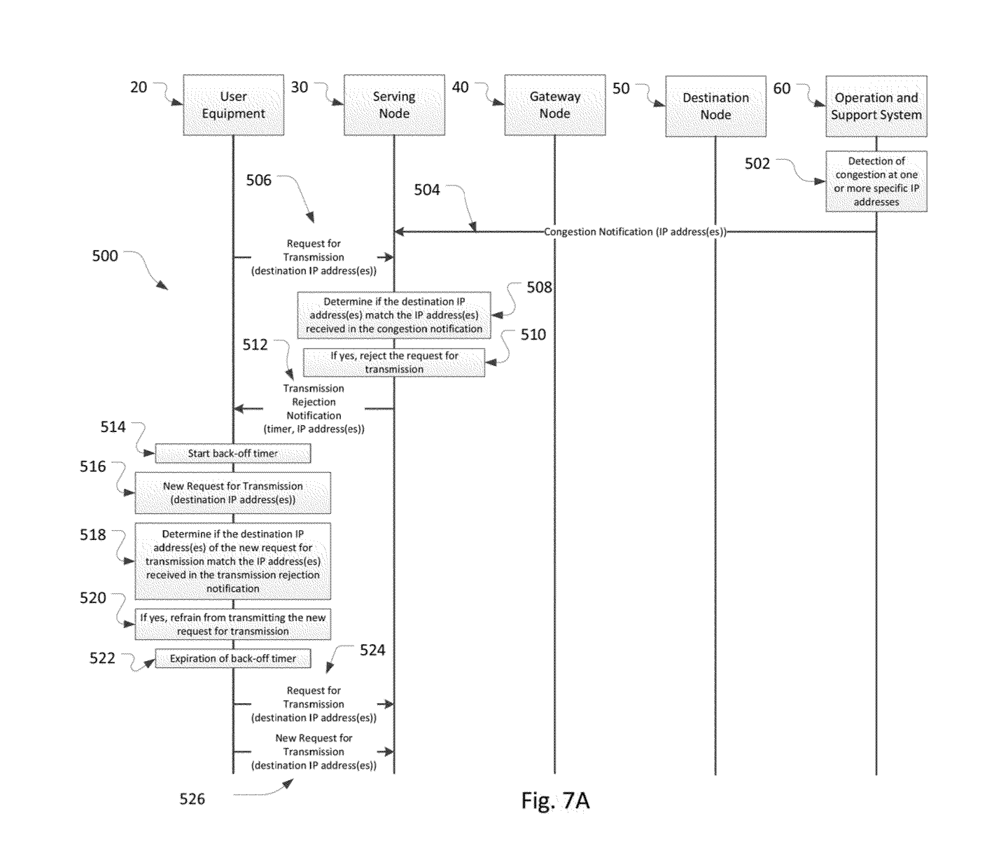

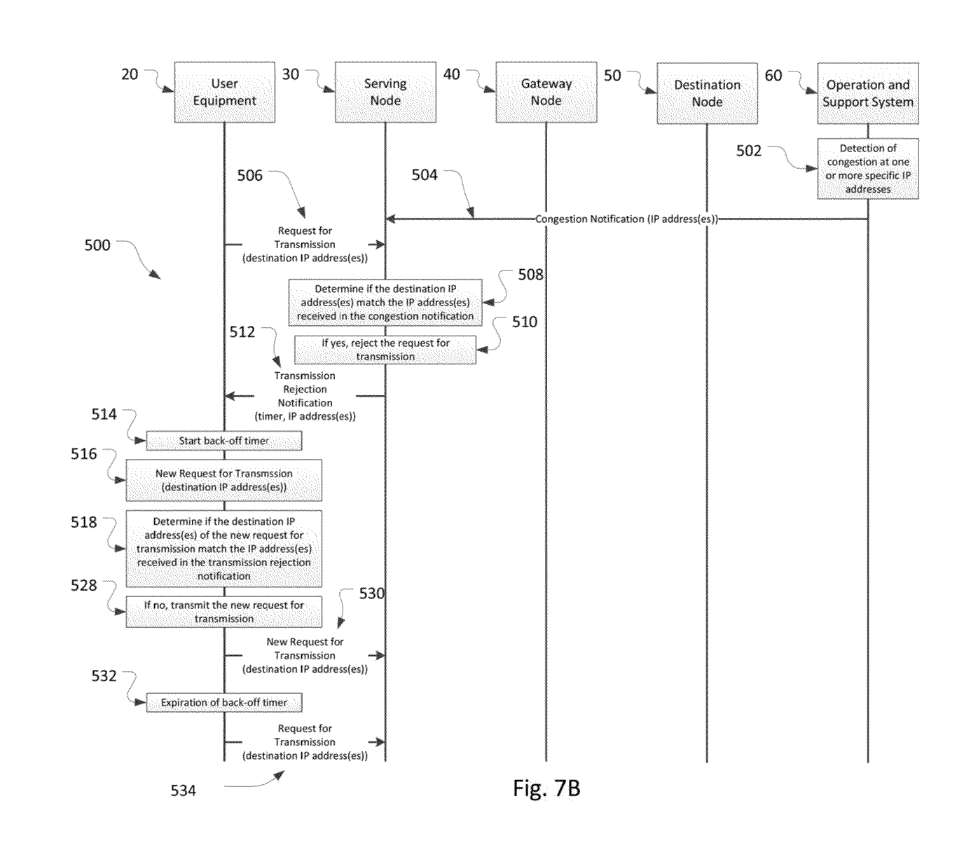

Referring now to FIGS. 7A and 7B, an exemplary message flow and signaling diagram 500 according to another embodiment of the present invention will now be described. In embodiment 500, the OSS 60 detects congestion, at 502, at one or more addresses. The OSS 60 then sends (e.g. broadcasts) a congestion notification, at 504, to all the serving nodes 30. In the embodiment 500, the congestion notification comprises the one or more IP addresses which congestion has been determined to associated to.

Later, at 506, the serving node 30 receives a request for transmission from a UE 20. The request for transmission comprises at least one destination address.

Then, as in previous embodiments 100, 200, 300 and 400, the serving node 30, determines, at 508, whether the at least one destination address of the request for transmission matches the at least one congested address of the congestion notification.

If there is no match, the serving node 30 proceeds with the request for transmission and a connection between UE 20 and destination node 50 is established as in FIG. 2A.

However, if there is a match between the at least one destination address of the request for transmission and the at least one congested address of the congestion notification, then the serving node 30 rejects, at 510, the request for transmission, and transmits, at 512 a transmission rejection notification to UE 20. In the present embodiment, the transmission rejection notification comprises a timer value and a list of the matching destination address(es) (i.e. the destination address(es) of the request for transmission which match the congested address(es)).

At 514, UE 20 starts a back-off timer with the timer value. Then, at 516, the UE 20 generates a new request for transmission (e.g. for new IP packets to be sent). At 518, the UE 20 determines whether the destination address(es) of the new request for transmission matches the congested address(es) comprised in the transmission rejection notification.

If there is a match, the UE 20 refrains, at 520, from transmitting the new request for transmission. Once the timer expires, at 522, the UE 20 transmits both the rejected request for transmission, at 524, and the new request for transmission, at 526.

Otherwise, if there is no match, at 528, UE 20 transmits the new request for transmission to serving node 30, at 530. Once the timer expires, at 532, the UE 20 transmits the rejected request for transmission, at 534.

By temporarily refraining from transmitting new requests for transmission to destination addresses which the UE 20 already knows to be congested, congestion can be further mitigated at the congested addresses and processing can be reduced at the serving nodes 30.

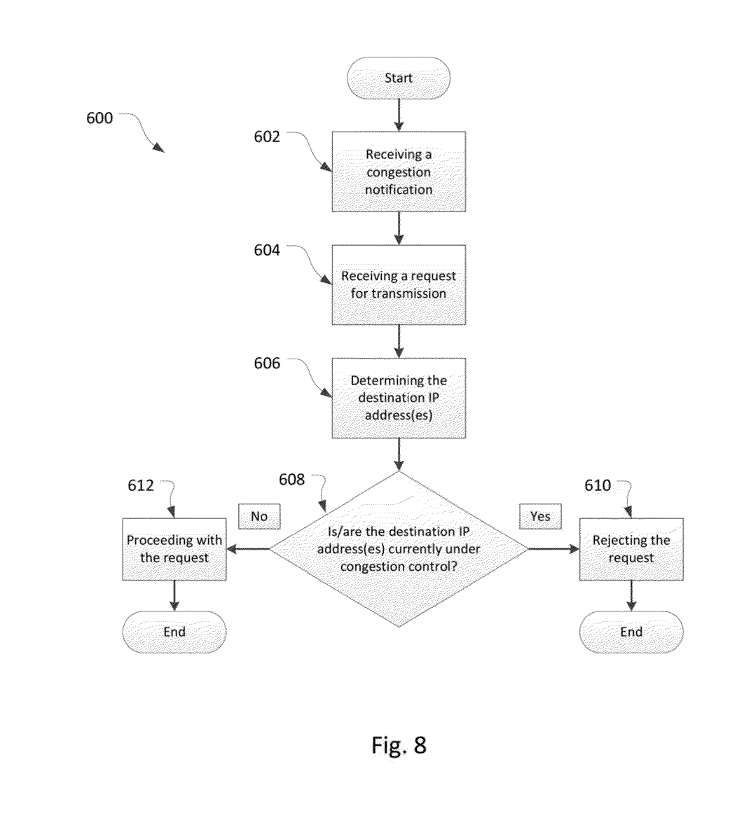

An embodiment of the present invention as implemented by a network node (e.g. serving node 30) can be further illustrated by the flow chart 600 depicted in FIG. 8. In embodiment 600, the network node receives, at 602, a congestion notification comprising one or more addresses determined be congested. At 604, the network node then receives a request for transmission from a UE. At 606, the network node determines the one or more destination addresses of the request for transmission and compares, at 608, the one or more destination addresses of the request for transmission with the one or more congested addresses comprised in the congestion notification. If there is no match, the network node proceeds with the request for transmission, at 612. If there is at least one match, the network node rejects the request for transmission, at 610. The rejection of the request for transmission may be followed by the transmission of a transmission rejection notification to the UE.

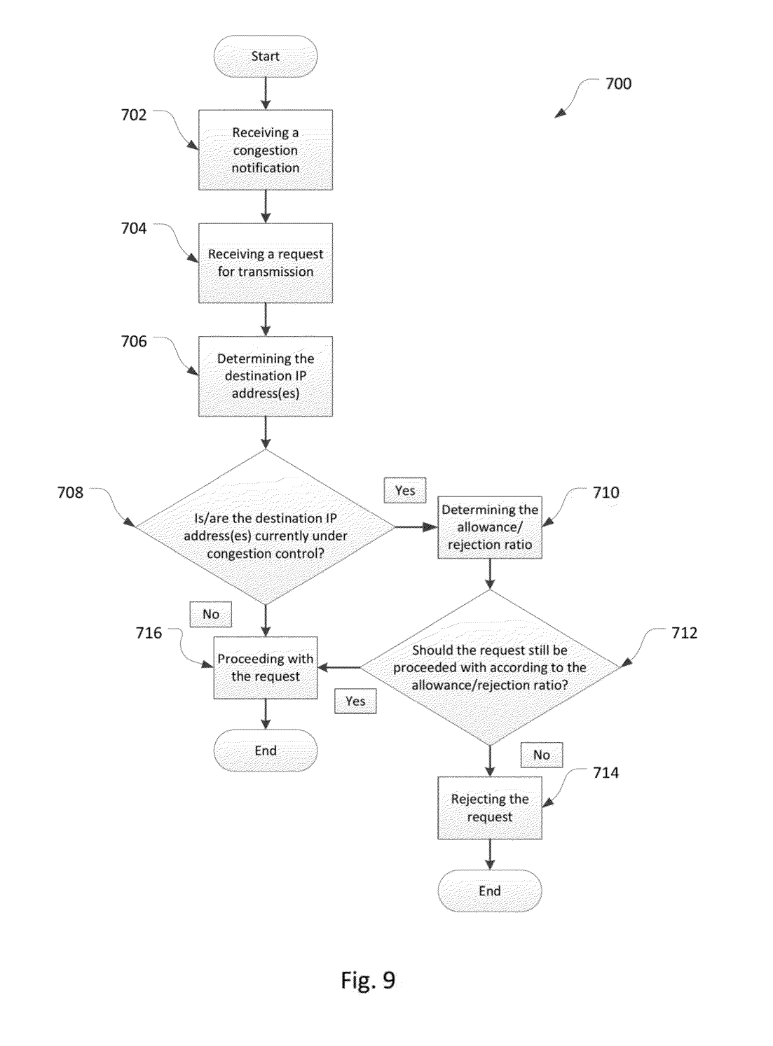

Another embodiment of the present invention as implemented by a network node (e.g. serving node 30) can be further illustrated by the flow chart 700 depicted in FIG. 9. In embodiment 700, the network node receives, at 702, a congestion notification comprising one or more addresses determined be congested and an allowance/rejection ratio (as in the embodiment of FIGS. 4A and 4B). At 704, the network node then receives a request for transmission from a UE. At 706, the network node determines the one or more destination addresses of the request for transmission and compares, at 708, the one or more destination addresses of the request for transmission with the one or more congested addresses comprised in the congestion notification. If there is no match, the network node proceeds with the request for transmission, at 716. If there is at least one match, the network node determines the allowance/rejection ratio, at 710, and determines whether the request for transmission should still be proceeded with according to the allowance/rejection ratio. If yes, the network node proceeds with the request for transmission, at 716. If no, the network node rejects the request for transmission, at 714. Again, the rejection of the request for transmission may be followed by the transmission of a transmission rejection notification to the UE.

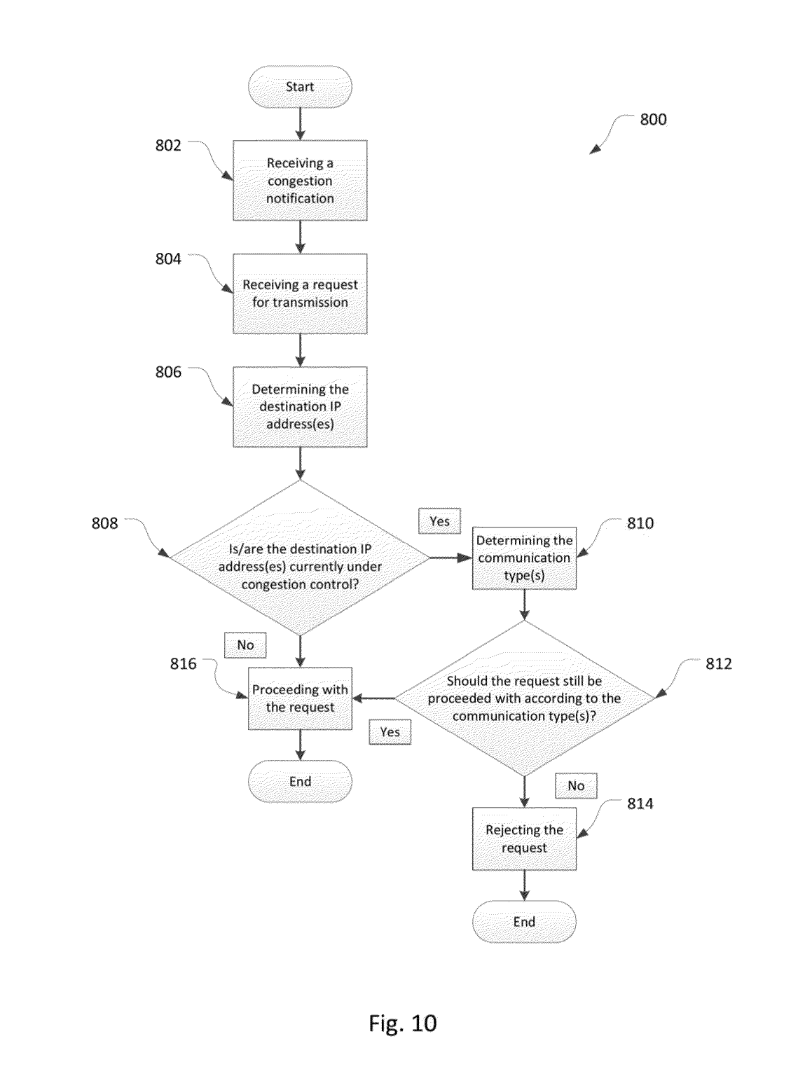

Another embodiment of the present invention as implemented by a network node (e.g. serving node 30) can be further illustrated by the flow chart 800 depicted in FIG. 10. In embodiment 800, the network node receives, at 802, a congestion notification comprising one or more addresses determined be congested and one or more communication types (as in the embodiment of FIGS. 5A and 5B). At 804, the network node then receives a request for transmission from a UE. At 806, the network node determines the one or more destination addresses of the request for transmission and compares, at 808, the one or more destination addresses of the request for transmission with the one or more congested addresses comprised in the congestion notification. If there is no match, the network node proceeds with the request for transmission, at 816. If there is at least one match, the network node determines the one or more communication types of the request for transmission, at 810, and compares them with the one or more communication types comprised in the congestion notification. In the event of a match, the network node can either proceed with the request for transmission, at 816, or reject the request for transmission, at 814. The rejection of the request for transmission may be followed by the transmission of a transmission rejection notification to the UE.

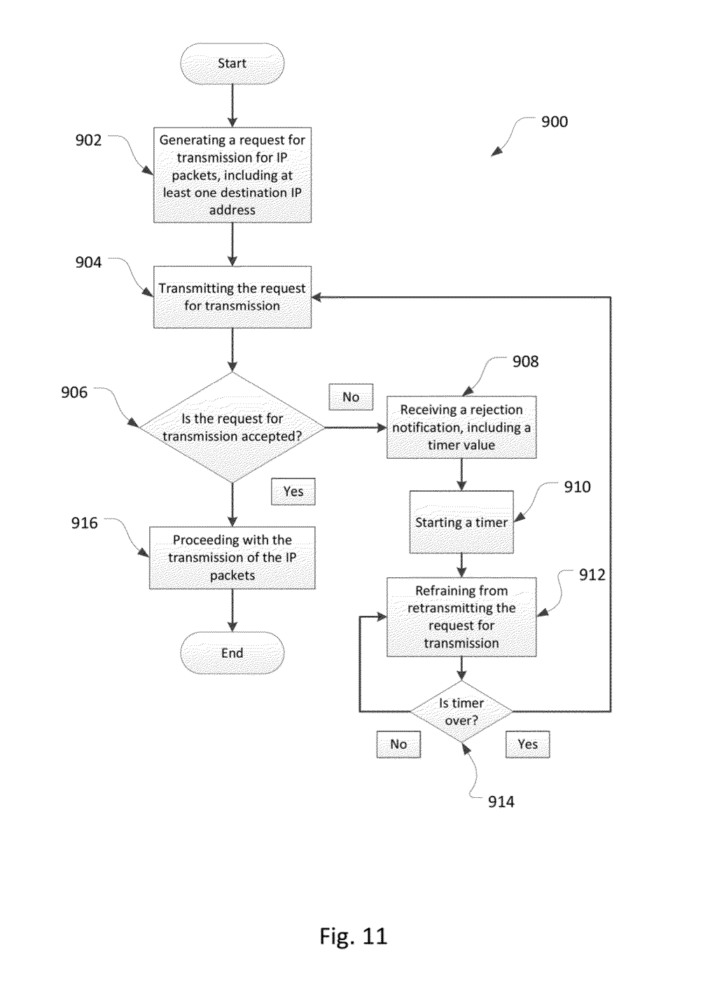

An embodiment of the present invention as implemented by a UE (e.g. UE 20) can be further illustrated by the flow chart 900 depicted in FIG. 11. In embodiment 900, the UE generates, at 902, a request for transmission for IP packets to be transmitted. The request for transmission comprises at least one destination IP address. At 904, the UE transmits the request for transmission to a serving node (e.g. serving node 30). At 906, the UE determines whether the request for transmission is accepted or rejected. If the request for transmission is accepted, the UE proceeds with the transmission of the IP packets, at 916. Otherwise, the UE receives, at 908, a transmission rejection notification which comprises a timer value. At 910, the UE starts a timer. Until the expiration of the timer, which is determined at 914, the UE refrains, at 912, from retransmitting the request for transmission. Once the timer expires, the UE retransmits the request for transmission, at 904.

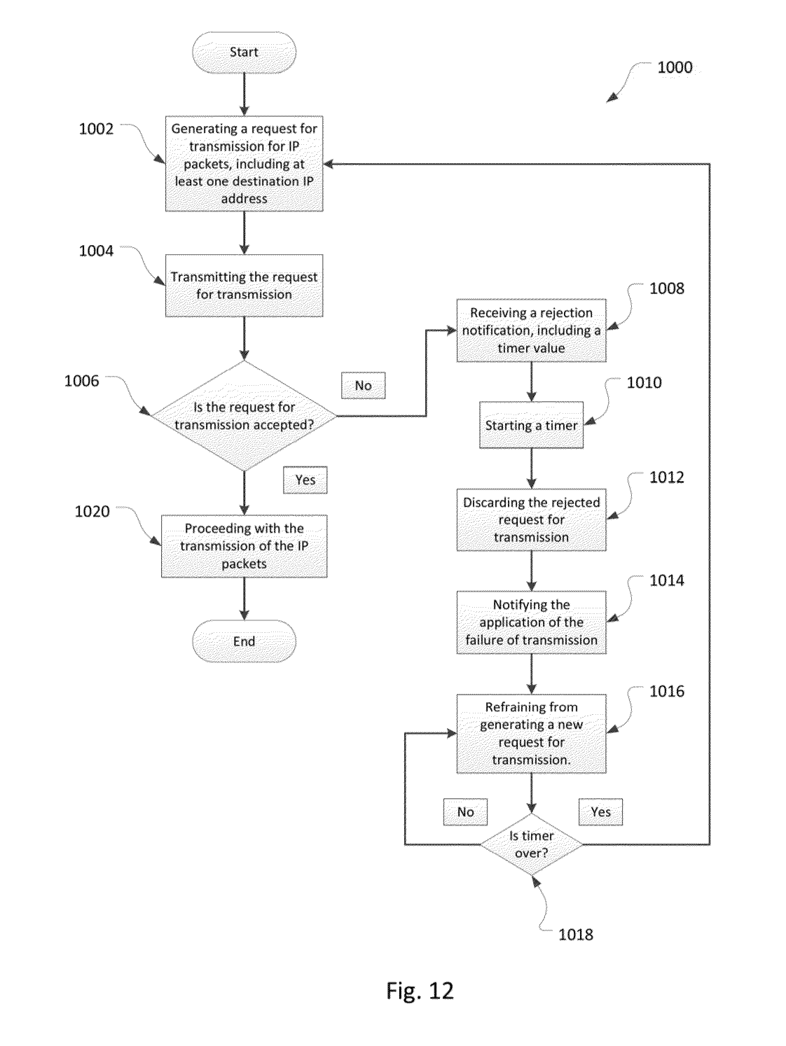

An embodiment of the present invention as implemented by a UE (e.g. UE 20) can be further illustrated by the flow chart 1000 depicted in FIG. 12. In embodiment 1000, the UE generates, at 1002, a request for transmission for IP packets to be transmitted. The request for transmission comprises at least one destination IP address. At 1004, the UE transmits the request for transmission to a serving node (e.g. serving node 30). At 1006, the UE determines whether the request for transmission is accepted or rejected. If the request for transmission is accepted, the UE proceeds with the transmission of the IP packets, at 1020. Otherwise, the UE receives, at 1008, a transmission rejection notification which comprises a timer value. At 1010, the UE starts a timer. At 1012, the UE discards the rejected request for transmission and then notifies, at 1014, the requesting application (e.g. the application running on the UE that was responsible for the request for transmission) that the transmission has failed. Then, until the expiration of the timer, which is determined at 1018, the UE refrains, at 1016, from generating new requests for transmission. Once the timer expires, the UE can once again generate requests for transmission, at 1002.

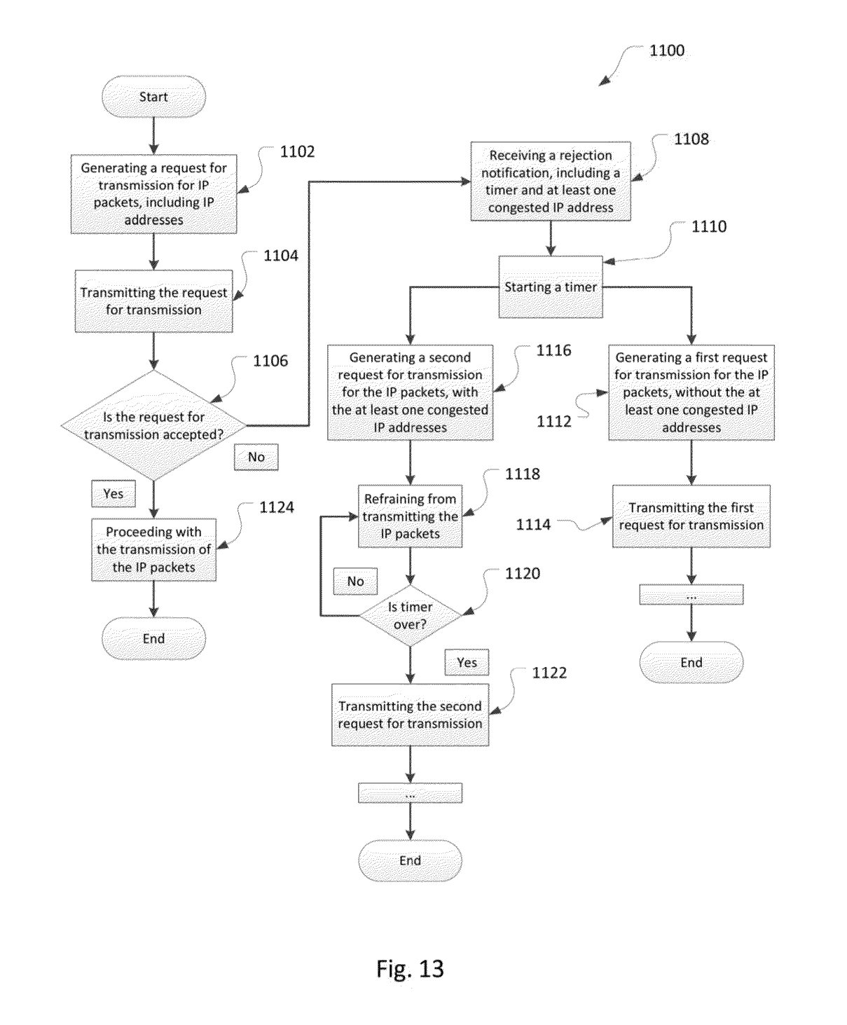

Another embodiment of the present invention as implemented by a UE (e.g. UE 20) can be further illustrated by the flow chart 1100 depicted in FIG. 13. In embodiment 1100, the UE generates, at 1102, a request for transmission for IP packets to be transmitted. The request for transmission comprises at least two destination IP addresses. At 1104, the UE transmits the request for transmission to a serving node (e.g. serving node 30). At 1106, the UE determines whether the request for transmission is accepted or rejected. If the request for transmission is accepted, the UE proceeds with the transmission of the IP packets, at 1124. Otherwise, the UE receives, at 1108, a transmission rejection notification which comprises a timer value and at least one congested IP address. At 1110, the UE starts a timer. Then the UE generates, at 1112, a first request for transmission for the IP packets to be transmitted to non-congested addresses. The UE then transmits, at 1114, the first modified request for transmission to the serving node. At more or less the same time, the UE generates at 1116, a second request for transmission for the IP packets to be transmitted to congested addresses. However, unlike the modified request for transmission, the UE refrains from transmitting the second request for transmission, at 1118, until the expiration of the timer, which is determined at 1120. Once the timer expires, the UE transmits the second request for transmission, at 1122.

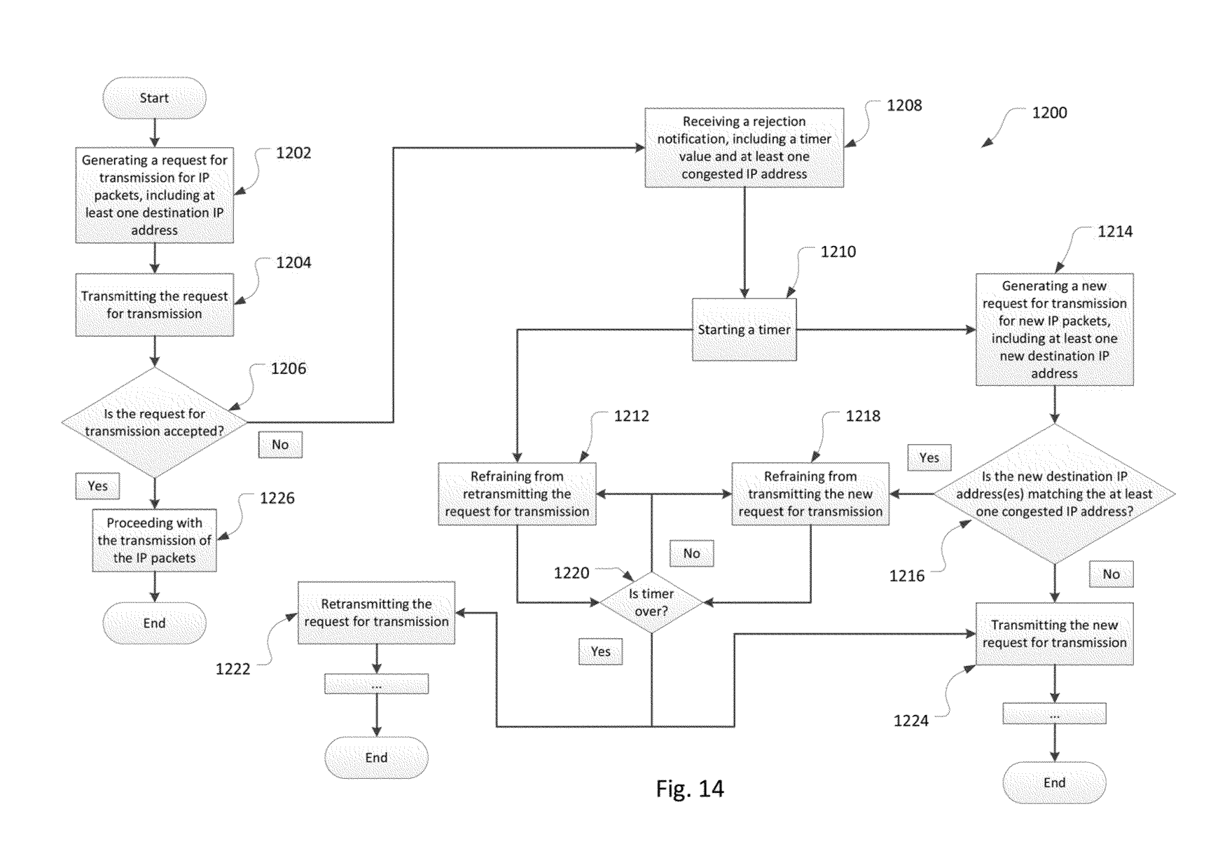

Another embodiment of the present invention as implemented by a UE (e.g. UE 20) can be further illustrated by the flow chart 1200 depicted in FIG. 14. In embodiment 1200, the UE generates, at 1202, a request for transmission for IP packets to be transmitted. The request for transmission comprises at least one destination IP address. At 1204, the UE transmits the request for transmission to a serving node (e.g. serving node 30). At 1206, the UE determines whether the request for transmission is accepted or rejected. If the request for transmission is accepted, the UE proceeds with the transmission of the IP packets, at 1226. Otherwise, the UE receives, at 1208, a transmission rejection notification which comprises a timer value and at least one congested destination address. At 1210, the UE starts a timer. Then the UE generates, at 1214, a new request for transmission for new IP packets to be transmitted. The new request for transmission comprises at least one destination IP address. Then, the UE determines, at 1216, whether the at least one destination address matches the at least one congested address comprised in the transmission rejection notification. If there is no match, the UE transmits the new request for transmission, at 1224. However, if there is at least one match, the UE refrains from transmitting the new request for transmission, at 1218, until the expiration of the timer, which is determined at 1220. Meanwhile, the UE also refrains from retransmitting the rejected request for transmission, at 1212, until the expiration of the timer, which is determined at 1220. Once the timer expires, the UE retransmits the rejected request for transmission, at 1222, and transmits the new request for transmission, at 1224.

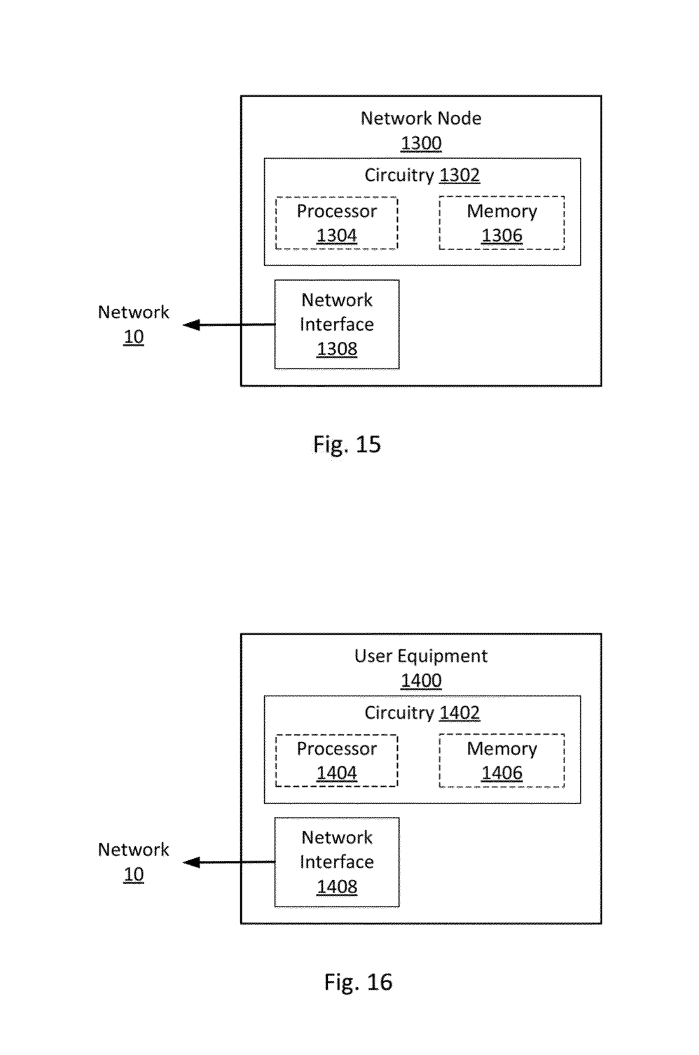

Referring now to FIG. 15, an exemplary embodiment of a network node 1300, e.g. serving node 30, is illustrated. Without limitations, network node 1300 illustrated in FIG. 15 may be used to implement the embodiments shown in FIGS. 2A to 10.

Network node 1300 generally comprises circuitry 1302 (e.g. processor 1304 and memory 1306) and a communication interface 1308 operatively connected thereto. The communication interface 1308 provides access to the network 10. The circuitry 1302 allows the network node 1300 to carry out the methods described (e.g. the methods described with reference to the flow charts of FIGS. 8 to 10).

Referring now to FIG. 16, an exemplary embodiment of user equipment 1400, e.g. UE 20, is illustrated. Without limitations, user equipment 1400 illustrated in FIG. 16 may be used to implement the embodiments shown in FIGS. 2A to 7, and 11 to 14.

User equipment 1400 generally comprises circuitry 1402 (e.g. processor 1404 and memory 1406) and a communication interface 1408 operatively connected thereto. The communication interface 1408 provides access to the network 10. The circuitry 1402 allows the network node 1400 to carry out the methods described (e.g. the methods described with reference to the flow charts of FIGS. 11 to 14).

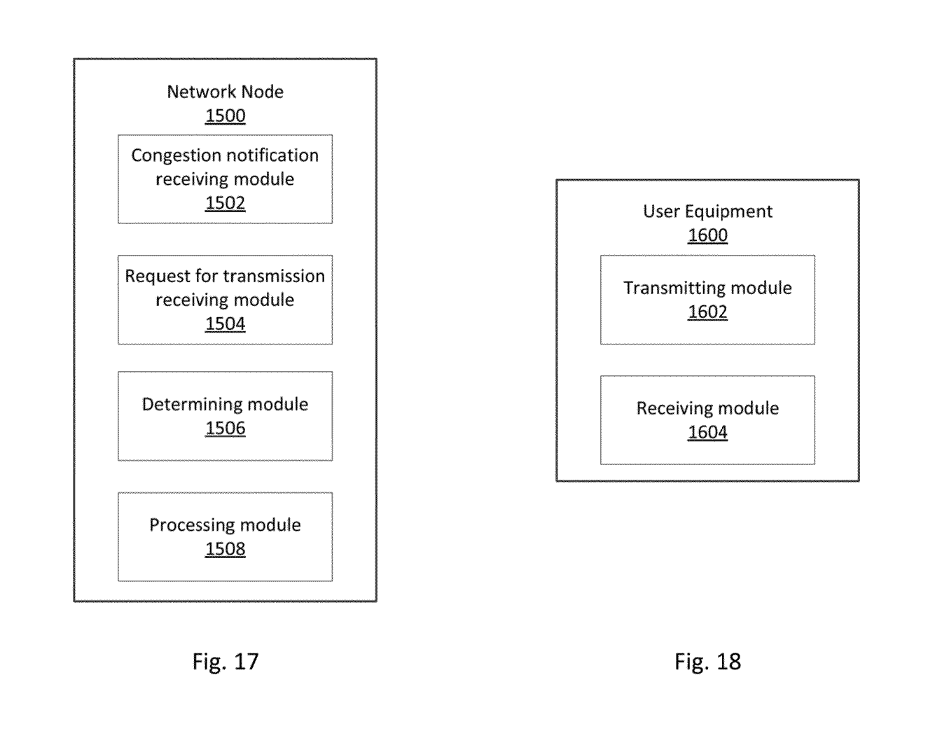

Referring to FIG. 17, an exemplary embodiment of a network node 1500, e.g. serving node 30, is illustrated. Without limitations, network node 1500 illustrated in FIG. 17 may be used to implement the embodiments shown in FIGS. 2A to 10.

Network node 1500 generally comprises a congestion notification receiving module 1502 configured to receive a congestion notification comprising an address which congestion has been detected to be associated to. Network node 1500 also comprises a request for transmission receiving module 1504 configured to receive a request for transmission from a UE, the request for transmission comprising a destination address. Network node 1500 also comprises a determining module 1506 configured to determine whether the destination address comprised in the request for transmission matches the address comprised in the congestion notification, and a processing module 1508 configured to proceed with the request for transmission if the destination address comprised in the request for transmission does not match the address comprised in the congestion notification, or to transmit a transmission rejection notification to the UE and refrain from proceeding with the request for transmission if the destination address comprised in the request for transmission matches the address comprised in the congestion notification.

Referring now to FIG. 18, an exemplary embodiment of user equipment 1600, e.g. UE 20, is illustrated. Without limitations, user equipment 1600 illustrated in FIG. 18 may be used to implement the embodiments shown in FIGS. 2A to 7, and 11 to 14.

User equipment 1600 generally comprises a transmitting module 1602 configured to transmit a request for transmission to a network node, the request for transmission comprising a destination address, and a receiving module 1604 configured to receive a transmission rejection notification from the network node.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

1. A method to control congestion in a communication network, the method comprising, at a network node:
receiving a congestion notification comprising an address which congestion has been detected to be associated to;
receiving a request for transmission from a user equipment (UE), the request for transmission comprising a destination address;
determining whether the destination address comprised in the request for transmission matches the address comprised in the congestion notification; and
in accordance with determining whether the destination address comprised in the request for transmission matches the address comprised in the congestion notification, proceeding with the request for transmission if the destination address comprised in the request for transmission does not match the address comprised in the congestion notification, or transmitting a transmission rejection notification to the UE and refraining from proceeding with the request for transmission if the destination address comprised in the request for transmission matches the address comprised in the congestion notification.

2. (canceled)

3. (canceled)

4. (canceled)

5. A method to control congestion as claimed in claim 1, wherein the congestion notification comprises a plurality of addresses which congestion has been detected to be associated to, wherein the request for transmission comprises a plurality of destination addresses, wherein the determining step comprises determining if any one of the plurality of destination addresses comprised in the request for transmission matches any one of the plurality of addresses comprised in the congestion notification, and wherein the proceeding step comprises, in accordance with determining if any one of the plurality of destination addresses comprised in the request for transmission matches any one of the plurality of addresses comprised in the congestion notification, proceeding with the request for transmission if there is no match between any one of the plurality of destination addresses comprised in the request for transmission and any one of the plurality of addresses comprised in the congestion notification, or transmitting a transmission rejection notification to the UE and refraining from proceeding with the request for transmission if at least one of the plurality of destination addresses comprised in the request for transmission matches at least one of the plurality of addresses comprised in the congestion notification.

6. (canceled)

7. A method to control congestion as claimed in claim 1, wherein the congestion notification further comprises an allowance/rejection ratio, and wherein the proceeding step further comprises, when the destination address comprised in the request for transmission matches the address comprised in the congestion notification, determining whether the request for transmission should still be allowed according to the allowance/rejection ratio, and in accordance with the determining whether the request for transmission should still be allowed according to the allowance/rejection ratio, proceeding with the request for transmission if the request for transmission should still be allowed, or transmitting a transmission rejection notification to the UE and refraining from proceeding with the request for transmission if the request for transmission should not still be allowed.

8. A method to control congestion as claimed in claim 1, wherein the congestion notification further comprises at least one communication type, and wherein the proceeding step further comprises, when the destination address comprised in the request for transmission matches the address comprised in the congestion notification, determining at least one communication type from the request for transmission, determining whether the at least one communication type of the request for transmission matches the at least one communication type comprised in the congestion notification, and in accordance with the determining whether the at least one communication type of the request for transmission matches the at least one communication type comprised in the congestion notification, proceeding with the request for transmission if the at least one communication type of the request for transmission matches the at least one communication type comprised in the congestion notification, or transmitting a transmission rejection notification to the UE and refraining from proceeding with the request for transmission if the at least one communication type of the request for transmission does not match the at least one communication type comprised in the congestion notification.

9. A method to control congestion as claimed in claim 1, wherein the congestion notification further comprises at least one communication type, and wherein the proceeding step further comprises, when the destination address comprised in the request for transmission matches the address comprised in the congestion notification, determining at least one communication type from the request for transmission, determining whether the at least one communication type of the request for transmission matches the at least one communication type comprised in the congestion notification, and in accordance with the determining whether the at least one communication type of the request for transmission matches the at least one communication type comprised in the congestion notification, proceeding with the request for transmission if the at least one communication type of the request for transmission does not match the at least one communication type comprised in the congestion notification, or transmitting a transmission rejection notification to the UE and refraining from proceeding with the request for transmission if the at least one communication type of the request for transmission matches the at least one communication type comprised in the congestion notification.

10. A method to control congestion as claimed in claim 1, wherein the transmission rejection notification comprises a waiting period value.

11. A method to control congestion as claimed in claim 10, wherein the waiting period value is comprised in the congestion notification.

12. A method to control congestion as claimed in claim 10, wherein the waiting period value is determined by the network node.

13. A method to control congestion as claimed in claim 1, wherein the request for transmission is a service request or an attach request.

14. A method to control congestion as claimed in claim 1, wherein the address comprised in the congestion notification is an Internet protocol (IP) address, and wherein the destination address comprised in the request for transmission is an IP address.

15. (canceled)

16. (canceled)

17. A network node comprising:
a communication interface;
circuitry operatively connected to the communication interface and adapted to:
receive a congestion notification, via the communication interface, the congestion notification comprising an address which congestion has been detected to be associated to;
receive a request for transmission, via the communication interface, from a user equipment (UE), the request for transmission comprising a destination address;
determine whether the destination address comprised in the request for transmission matches the address comprised in the congestion notification; and
in accordance with determining whether the destination address comprised in the request for transmission matches the address comprised in the congestion notification, proceed with the request for transmission if the destination address comprised in the request for transmission does not match the address comprised in the congestion notification, or cause the communication interface to transmit a transmission rejection notification to the UE and refrain from proceeding with the request for transmission if the destination address comprised in the request for transmission matches the address comprised in the congestion notification.

18. A network node as claimed in claim 17, wherein the congestion notification comprises a plurality of addresses which congestion has been detected to be associated to, wherein the request for transmission comprises a plurality of destination addresses, wherein the circuitry is adapted to determine if any one of the plurality of destination addresses comprised in the request for transmission matches any one of the plurality of addresses comprised in the congestion notification, and in accordance with determining if any one of the plurality of destination addresses comprised in the request for transmission matches any one of the plurality of addresses comprised in the congestion notification, to proceed with the request for transmission if there is no match between any one of the plurality of destination addresses comprised in the request for transmission and any one of the plurality of addresses comprised in the congestion notification, or to cause the communication interface to transmit a transmission rejection notification to the UE and refrain from proceeding with the request for transmission if at least one of the plurality of destination addresses comprised in the request for transmission matches at least one of the plurality of addresses comprised in the congestion notification.

19. (canceled)

20. A network node as claimed in claim 17, wherein the congestion notification further comprises an allowance/rejection ratio, and wherein the circuitry is further adapted to, when the circuitry determines the destination address comprised in the request for transmission matches the address comprised in the congestion notification:
determine whether the request for transmission should still be allowed according to the allowance/rejection ratio; and
in accordance with the determining whether the request for transmission should still be allowed according to the allowance/rejection ratio, proceed with the request for transmission if the request for transmission should still be allowed, or cause the communication interface to transmit a transmission rejection notification to the UE and refrain from proceeding with the request for transmission if the request for transmission should not still be allowed.

21. A network node as claimed in claim 17, wherein the congestion notification further comprises at least one communication type, and wherein the circuitry is further adapted to, when the destination address comprised in the request for transmission matches the address comprised in the congestion notification:
determine at least one communication type from the request for transmission;
determine whether the at least one communication type of the request for transmission matches the at least one communication type comprised in the congestion notification; and
in accordance with the determining whether the at least one communication type of the request for transmission matches the at least one communication type comprised in the congestion notification, proceed with the request for transmission if the at least one communication type of the request for transmission matches the at least one communication type comprised in the congestion notification, or cause the communication interface to transmit a transmission rejection notification to the UE and refrain from proceeding with the request for transmission if the at least one communication type of the request for transmission does not match the at least one communication type comprised in the congestion notification.

22. A network node as claimed in claim 17, wherein the congestion notification further comprises at least one communication type, and wherein the circuitry is further adapted to, when the destination address comprised in the request for transmission matches the address comprised in the congestion notification:
determine at least one communication type from the request for transmission;
determine whether the at least one communication type of the request for transmission matches the at least one communication type comprised in the congestion notification; and
in accordance with the determining whether the at least one communication type of the request for transmission matches the at least one communication type comprised in the congestion notification, proceed with the request for transmission if the at least one communication type of the request for transmission does not match the at least one communication type comprised in the congestion notification, or cause the communication interface to transmit a transmission rejection notification to the UE and refrain from proceeding with the request for transmission if the at least one communication type of the request for transmission matches the at least one communication type comprised in the congestion notification.

23. A network node as claimed in claim 17, wherein the transmission rejection notification comprises a waiting period value.

24. A network node as claimed in claim 23, wherein the waiting period value is comprised in the congestion notification.

25. A network node as claimed in claim 23, wherein the waiting period value is determined by the network node.

26. A network node as claimed in claim 17, wherein the request for transmission is a service request or an attach request.

27. A network node as claimed in claim 17, wherein the address comprised in the congestion notification is an Internet protocol (IP) address, and wherein the destination address comprised in the request for transmission is an IP address.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)
